(19) United States
(12) Patent Application Publication
(10) Pub. No.: US 2023/0353196 A1
(43) Pub. Date: Nov. 2, 2023

(54) MINIATURIZED 5G DUAL-BAND MIMO RADIATING SYSTEM AND DEVICE THEREOF

(71) Applicants: Shanmathi S, Chennai (IN); Malathi K, Chennai (IN); Sakthivel P, Chennai (IN); Gulam Nabi Alsath M, Chengalpattu (IN); Jothy G, Chennai (IN); Shini R, Chennai (IN); Lavanya V, Chennai (IN)

(72) Inventors: Shanmathi S, Chennai (IN); Malathi K, Chennai (IN); Sakthivel P, Chennai (IN); Gulam Nabi Alsath M, Chengalpattu (IN); Jothy G, Chennai (IN); Shini R, Chennai (IN); Lavanya V, Chennai (IN)

(21) Appl. No.: 17/661,050

(22) Filed: Apr. 28, 2022

(51) Int. Cl. H04B 7/0413; H01Q 21/06; H01Q 13/10; H01Q 1/48; H01Q 5/307; H01Q 13/16

(52) U.S. Cl. CPC H04B 7/0413; H01Q 1/48; H01Q 5/307; H01Q 13/106; H01Q 13/16; H01Q 21/06

(57) ABSTRACT

The embodiments herein provide a miniaturized dual-band radiating system providing a directional radiation pattern for Vehicular to Network (V2N) applications. The planar Simple Slotted Square (SSS) radiating system is designed with dimensions 0.114λ₀ × 0.114λ₀ × 0.0016λ₀, where the λ₀ denotes the wavelength of the minimum frequency FR1. The designed radiating system is incorporated with a SSS radiator over a dielectric substrate and Full Ground Plane (FGP) to achieve a directional radiation pattern. The proposed SSS radiating system design operates at the 5G NR n2 band (FR1-1.9 GHz) and safety band (FR2-5.9 GHz) of DSRC in ITS. The proposed single element radiating system is positioned side-by-side to realize the MIMO system. For the MIMO radiating system, the array parameters such as isolation, diversity gain, and ECC are measured and are well within the required values. This embodiment is suitable for placement inside the automobile’s shark fin housing to establish uninterrupted communications.

### TECHNICAL FIELD

The present invention is related to microwave radiating systems and more particularly the miniaturized 5G Dual-Band MIMO Radiating Systems is suitable for mounting on a vehicle for services such as PCS (Personal Communication Service) and dedicated short-range communication (DSRC).

### BACKGROUND OF THE INVENTION

The rise in 5G technology has drastically increased the quality of communication and tremendous speed in wireless communications. Radiating systems play a crucial role in wireless communication systems. As per the Release 17 of the respective 3GPP technical standard (TS 38.101), the channel bandwidths required for these specified frequencies have stated 35 MHz as one of the supported bandwidths for 1.9 GHz. By the fact sheet of the Federal Communications Commission (FCC), a dedicated 30 MHz of 5.9 GHz (5.895-5.925 GHz) for accomplishing ITS (Intelligent Transport Systems) goals in this band. FCC believes that this band will be of utility for transportation and vehicular safety technology. Unlike wideband radiating systems, isolation of narrowband radiating systems is high because of the highly selective filter. Narrowband radiating systems require less transmission power, lower design complexity, and reduced interference. On the other hand, when more than one operating frequency is incorporated into a single device, the requirement of transmitted power could be reduced. This would increase the requirements of gain, efficiency, and other related radiating system parameters that have to be considered for systemimplementation. Further to introduce MIMO, multiple radiating systems are placed to enhance the versatility of the radiating system in real-time applications.

The requirement for MIMO technology increases with the rapid surge in the communication industry after 5G involvement. This necessitates the enhancement of the fundamental parameters of the MIMO radiating system such as diversity gain, isolation, Envelope Correlation Coefficient (ECC), Diversity Gain (DG), Mean Effective Gain (MEG). Generally, directional radiation patterns are preferred for Vehicle to Network (V2N) communication. Vehicular Communication is the burgeoning of communication between vehicles to everything that involves vehicles, infrastructure, pedestrians, and network communications. Large size, high profile, complex structures, poor isolation between radiating systems, and the need for a separate isolation structure to attain the required isolation between the radiating systems are major concerns in MIMO radiating systems. The proposed radiating system is designed by overcoming the issues mentioned above with quintessential features such as compactness, miniaturization, simple design, and good radiation and impedance performance.

### OBJECTIVE OF THE INVENTION

The primary objective of the present invention is to design a miniaturized dual-band radiating system.

Yet another objective of the present invention is to design a compact microstrip radiator backed with a dielectric substrate and full ground plane for providing the required directional radiation pattern.

Yet another objective of the present invention is to design a MIMO radiating system with the smallest inter-element spacing.

Yet another objective of the present invention is to reduce the coupling effect between the two radiators integrated into MIMO radiating system without incorporating any separate isolation structure.

Yet another objective of the present invention is to make the proposed antenna compatible with onboard performance in the vehicular scenario.

These and other objects and advantages of the present invention will become readily apparent from the following detailed description taken in conjunction with the accompanying drawings.

### SUMMARY OF THE INVENTION

The various embodiments of the present invention provide a dual-band radiating system to provide a MIMO configuration with minimum interference between the single element radiators. The embodiments of the present invention provide a miniaturized dual-band radiating system comprising of a Simple Slotted Square (SSS) patch radiating system encompassing the Concentric Ring Slot (CRS) extended with Top Centered Loop Slot (TCLS) and Coupled U-Slot (CUS). At the centre of the patch, the Inverted U-Slot (IUS) is positioned which is then converted into Modified W-Slot (MWS). The bandwidth enhancement is attained using Bottom Centered Horizontal Stub (BCHS). According to an embodiment, the miniaturized dual-band radiating system, includes the Simple Slotted Square (SSS) Patch layered over the dielectric and Full Ground Plane (FGP) to get the operating resonance at the 5G NR n2 band (FR1-1.9 GHz) and safety band of Intelligent Transportation Systems (ITS) (FR2-5.9 GHz).

According to an embodiment, the Simple Slotted Square (SSS) radiator includes a Concentric Ring Slot (CRS) adjacent to the corners and edges of the Simple Square Patch (SSP) to provide the resonance at high frequencies utilizing the quasi TEM structure.

According to an embodiment, the Simple Slotted Square (SSS) radiator a Top Centered Loop Slot (TCLS) is added as the extension to Concentric Ring Slot (CRS) providing frequency shift by increasing electrical length. This increase in electrical length leads to a frequency shift towards the lower frequency.

According to an embodiment, the Simple Slotted Square (SSS) radiator including Top Centered Loop Slot (TCLS) is defined by performing a parametric sweep starting from a single slot from the Concentric Ring Slot (CRS) and then extended it to a single curve and the resonance is just shifted from higher to the lower frequency.

According to an embodiment, the Simple Slotted Square (SSS) radiator includes a Top Centered Loop Slot (TCLS) extended with a second and third curve providing the desired frequency resonance at 5G NR n2 band (FR1-1.9 GHz).

According to an embodiment, the Simple Slotted Square (SSS) radiator includes Coupled U-Slot (CUS) to impede the inductance effect of the radiator between the Top Centered Loop Slot (TCLS) and Concentric Ring Slot (CRS) for coupling purposes resulting in the introduction of another band around the frequency.

According to an embodiment, the Simple Slotted Square (SSS) radiator includes Coupled U-Slot (CUS) is the combination of an Asymmetrical U-Slot (AUS) and a Thin U-Slot (TUS) which helps in increasing the coupling between the slots by increasing the physical length of the radiator.

According to an embodiment, the Simple Slotted Square (SSS) radiator includes Two Inverted U-Slots (IUS) that are added at the centre of the radiator to obtain the necessary frequency resonance at the desired mark.

According to an embodiment, the Simple Slotted Square (SSS) radiator includes Inverted U-Slots (IUS) that are then reshaped into a Modified W-Slot (MWS) to acquire the requisite dual-band resonance for the radiator.

According to an embodiment, the Simple Slotted Square (SSS) radiator includes Bottom Centered Horizontal Stub (BCHS) embodied along with the Concentric Ring Slot (CRS) at the bottom edge’s centre to provide the required bandwidth enhancement.

According to an embodiment, the Simple Slotted Square (SSS) radiator is placed over a dielectric substrate and the Full Ground Plane (FGP) at the bottom leads to the directional radiation pattern with reduced back lobes.

According to an embodiment, the Simple Slotted Square (SSS) radiator includes a MIMO configuration with two single elements Simple Slotted Square (SSS) radiating system placed adjacent to one another with a spacing determined by the parametric sweep with enhanced isolation Characteristics without any dedicated decoupling structures. The estimated MIMO parameters such as Envelope Correlation Coefficient (ECC) and Diversity Gain (DG) are also well within the required range.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will occur to those skilled in the art from the following description of the preferred embodiment and the accompanying drawings in which:

FIG. 1 illustrates a front view of the miniaturized dual-band radiating system according to one embodiment of the present invention.

FIG. 2 illustrates a rear view of the miniaturized dual-band radiating system of FIG. 1, according to an embodiment of the present invention.

FIG. 3 illustrates a front view of the MIMO miniaturized dual-band radiating system of FIG. 1, according to an embodiment of the present invention.

Although the specific features of the present invention are shown in some drawings and not in others. This is done for convenience only as each feature may be combined with any or all of the other features following the present invention.

### DETAILED DESCRIPTION OF THE INVENTION

In the following detailed description, reference is made to the accompanying drawings that form a part hereof, and in which the specific embodiments that may be practiced are shown by way of illustration. These embodiments are described in sufficient detail to enable those skilled in the art to practice the embodiments and it is to be understood that the logical, mechanical, and other changes may be made without departing from the scope of the embodiments. The following detailed description is therefore not to be taken in a limiting sense.

The various embodiments of the present invention represent a dual-band radiating system that allows a MIMO configuration with minimal interference between single element radiators. A compact dual-band radiating system is provided by embodiments of the present invention, which include a Simple Slotted Square (SSS) patch radiating system including the Concentric Ring Slot (CRS) augmented with Top Centered Loop Slot (TCLS) and Coupled U-Slot (CUS). The Inverted U-Slot (IUS) is placed in the patch’s centre prior to getting altered to Modified W-Slot (MWS). Bottom Centered Horizontal Stub (BCHS) thus provides bandwidth improvement. The miniaturized dual-band radiating system, according to the embodiment, contains the Simple Slotted Square (SSS) Patch overlaid on the dielectric and Full Ground Plane (FGP) to get the operational frequency at the 5G NR n2 band (FR1-1.9 GHz) and safety band of Intelligent Transportation Systems (ITS) (FR2-5.9 GHz).

According to an embodiment, the Simple Slotted Square (SSS) radiator features a Concentric Ring Slot (CRS) near the corners and edges of the Simple Square Patch (SSP) to provide resonance at a much higher frequency by leveraging the quasi-TEM structure.

According to an embodiment, the Simple Slotted Square (SSS) radiator has an expansion to the Concentric Ring Slot (CRS), a Top Centered Loop Slot (TCLS). TCLS is introduced to provide frequency shift by enhancing electrical length. As the electrical length increases, the frequency shifts to the lower frequency.

According to an embodiment, the Simple Slotted Square (SSS) radiator encompasses the Top Centered Loop Slot (TCLS) is defined by a parametric sweep that commences with a single slot from the Concentric Ring Slot (CRS) and concludes with a single curve, with the resonance shifting from higher to the lower frequency.

According to an embodiment, the Simple Slotted Square (SSS) radiator to provide the appropriate frequency resonance at 5G NR n2 band in (FR1-1.9 GHz) expanded with a second and third curve from the Top Centered Loop Slot (TCLS).

According to an embodiment, Coupled U-Slot (CUS) is included in the Simple Slotted Square (SSS) radiator to reduce inductance between the Top Centered Loop Slot (TCLS) and Concentric Ring Slot (CRS) for coupling reasons, leading to the introduction of another band around the frequency.

According to an embodiment, The SSS (Simple Slotted Square) radiator encompasses Asymmetrical U-Slot (AUS) and a Thin U-Slot (TUS) combined to form Coupled U-Slot (CUS), which increases the physical length of the radiator and hence increases the coupling between the slots.

According to an embodiment, Two Inverted U-Slots (IUS) are inserted at the core of the Simple Slotted Square (SSS) radiator to alter the frequency resonance at the desired position.

According to an embodiment, to provide the required dual-band resonance, the Simple Slotted Square (SSS) radiator comprises Inverted U-Slots (IUS) that are then moulded into a Modified W-Slot (MWS).

According to an embodiment, the Bottom Centered Horizontal Stub (BCHS) is integrated along with the Concentric Ring Slot (CRS) at the bottom edge’s centre to offer the requisite bandwidth augmentation in the Simple Slotted Square (SSS) radiator.

According to an embodiment, the Simple Slotted Square (SSS) radiator is placed over a dielectric substrate and the Full Ground Plane (FGP) at the bottom leads to the directional radiation pattern with reduced back lobes.

According to an embodiment, the MIMO configuration of the Simple Slotted Square (SSS) radiator consists of two single elements Simple Slotted Square (SSS) radiating systems placed adjacent to one another with a spacing determined by the parametric sweep and enhanced isolation characteristics without the use of separate isolation structures.

According to an embodiment, MIMO characteristics Envelope Correlation Coefficient (ECC) and Diversity Gain (DG) are equally well within the necessary range in the invention proposed.

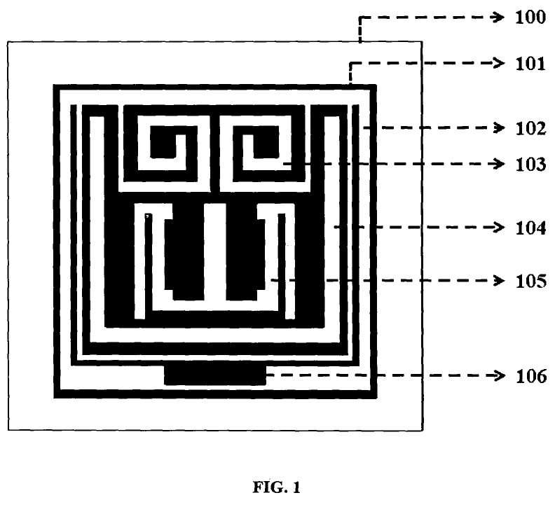

FIG. 1 illustrates a vehicular dual-band radiating system 100, according to one embodiment of the present invention. The radiating system includes a directional radiator containing a Simple Slotted Square (SSS) radiator 101 referred to as Quasi TEM structure, with Concentric Ring Slot (CRS) 102, Top Centered Loop Slot (TCLS) 103, Coupled U-Slot (CUS) 104, Modified W-Slot (MWS) 105, Bottom Centered Horizontal Stub (BCHS) 106 is designed to provide the required application bands. In an embodiment, the Simple Slotted Square (SSS) radiator 101 printed on a Rogers’s substrate has a width of 0.254 mm and a relative permittivity (ℇr) of 2.33 with a tangent loss of 0.0005.

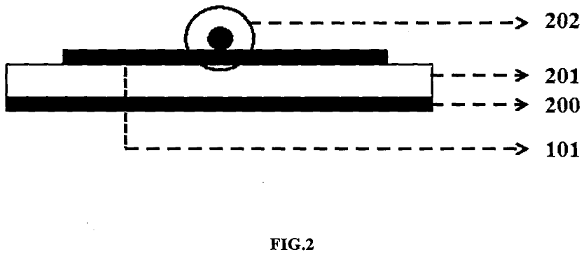

FIG. 2 illustrates a bottom view of the miniaturized vehicular dual-band radiating system 100. The Full Ground Plane (FGP) 200 is placed below the dielectric substrate Rogers 201 to enhance the isolation between the radiator and the ground. In an embodiment, the Simple Slotted Square (SSS) radiator 101 is placed over the substrate Rogers where the feed element 202 delivers the available power to the radiator for the desired performance. Using a dual-band radiating system, it is possible to discriminate the desired signals according to the user demand by proficiently mitigating the undesirable signals.

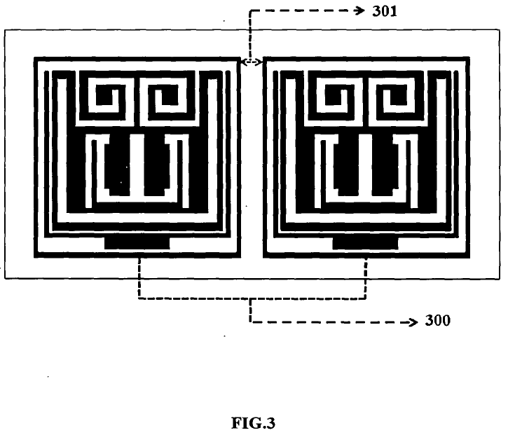

FIG. 3 illustrates the front view of the miniaturized vehicular dual-band radiating system 100 comprises two layers with Simple Slotted Square (SSS) radiator 101 present in the top layer and the bottom layer with the Full ground plane (FGP) 200. The top layer and bottom layer are segregated by Rogers RT5870 substrate 201 with a very low thickness of 0.254 mm, the dielectric constant of 2.33, and the loss tangent of 0.0005. The Simple Slotted Square (SSS) radiator 101 is placed adjacent to one another for the MIMO configuration of the presented invention. The isolation for the MIMO configurations is attained by the positioning of the two Simple Slotted Square (SSS) radiators determined by the parametric sweep. This parametric study of the spacing 301 between the two single elements is performed to define a better position for the MIMO positioning. This offers the following advantages for the MIMO Simple Slotted Square (MSSS) 300: better isolation characteristics, Envelope Correlation Coefficient (ECC) less than 0.3, and Diversity gain nearly equal to 10 dB

As a result, the vehicular dual-band radiating system provides a required narrow-band resonance for the 5G NR n2 band and a dedicated short-range communication band for Intelligent Transportation Systems. The radiating system radiates only at desired bands with the reflection coefficient above -10 dB. The vehicular miniaturized dual-band radiating system 100 offers a directional radiation pattern with spectrum efficiency, reduced fading, better isolation characteristics, and receiver connectivity suitable for radar sensing for far-field short-range communication.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments herein with modifications. Although the embodiments herein are described with various specific embodiments, it will be obvious for a person skilled in the art to practice the embodiments herein with modifications.

### ADVANTAGES OF THE INVENTION

The embodiments of the present invention provide a miniaturized dual-band radiating system using a microstrip patch antenna providing a directional radiation pattern for vehicular communication.

The embodiments of the present invention provide a radiating system developed on a thin and low electric loss dielectric substrate providing uniform electrical properties over a wide frequency range.

The embodiments of the present invention provide a miniaturized dual-band radiating system using by varying the physical length of the radiators for the 5G NR n2 band and the Safety band for vehicular communication.

The embodiments of the present invention provide a directional radiator comprises of a combination of simple techniques such as coplanar waveguide technology and coupled resonance method and hence it is highly suited for long-range communication.

The embodiments of the present invention provide a better gain and total radiation efficiency for the proposed single-element microstrip patch antenna.

The embodiments of the present invention provide a dual-band MIMO radiating system by placing them adjacent to one another at an appropriate distance without additional decoupling cells.

The embodiments of the present invention provide a dual-band MIMO radiating system without affecting the antenna parameters and radiation properties of the single element radiating system.

The embodiments of the present invention contribute the requisite values for the MIMO characteristics such as isolation, Envelope Correlation Coefficient and Diversity Gain.

The embodiments of the present invention facilitate a far-field study by performing the onboard analysis for vehicular communication.

We claim:

1. The miniaturized 5G dual-band MIMO radiating system comprises:
A dual-band directional radiator comprises of Simple Slotted Square (SSS) structure with a Full Ground Plane (FGP).
The radiator consists of the Ring Slot (RS), Extended Loop Slot (ELP), Coupled U slot (CUS), and Modified W Slot (MWS) for the desired operation.
The combination of Ring Slot (RS), and Extended Loop Slot (ELP) in the Simple Slotted Square (SSS) radiator offers FR1 5G NR n2 band.
The Coupled U slot (CUS), and Modified W Slot (MWS) in Simple Slotted Square (SSS) radiator offer an FR2 safety band as defined by ITS.
A coaxial probe feed is given at the radiator as the feed source on the bottom edge of the SSS radiator.
Single element Simple Slotted Square (SSS) radiator is placed adjacent to one another to form the MIMO configuration.

2. The miniaturized 5G dual-band MIMO radiating system as claimed in claim 1, wherein the directional SSS radiator achieves the desired dual-band resonance by positioning the SSS radiator over the FGP with the dielectric substrate in between them and backed with a Full Ground Plane (FGP).

3. The miniaturized 5G dual-band MIMO radiating system as claimed in claim 1, wherein the Simple Slotted Square (SSS) comprises of Ring Slot (RS), Extended Loop Slot (ELP), Coupled U slot (CUS), and Modified W Slot (MWS) to achieve the desired impedance matching at both the operating frequencies.

4. The miniaturized 5G dual-band MIMO radiating system as claimed in claim 1, wherein the combination of Ring Slot (RS), and Extended Loop Slot (ELP) provides FR1 5G NR n2 band in the Simple Slotted Square (SSS) radiator.

5. The miniaturized vehicular 5G dual-band MIMO radiating system as claimed in claim 1, wherein a Coupled U slot (CUS) and Modified W Slot (MWS) provides FR2 safety band by increasing the inductive effect of the radiator.

6. The miniaturized 5G dual-band MIMO radiating system as claimed in claim 1, wherein a coaxial probe feed is given at the radiator as the feed source in the bottom edge of the SSS radiator layered over a dielectric and FGP.

7. The miniaturized 5G dual-band MIMO radiating system as claimed in claim 1, wherein two Simple Slotted Square (SSS) radiators are placed adjacent to obtain MIMO configuration.

8. The miniaturized 5G dual-band MIMO radiating system as claimed in claim 1, wherein the MIMO parameters such as Envelope Correlation Coefficient and Diversity Gain of the proposed invention are well within the desired range.
